(19) United States
(12) Patent Application Publication
(10) Pub. No.: US 2012/0167345 A1
(43) Pub. Date: Jul. 5, 2012

(54) HANDLE TO OPEN ENCLOSED DOORS WITH HORIZONTAL ORIENTED AXIS OF ROTATION

(76) Inventor: JEAN-LOUIS ALAMON, Paris (FR)

(21) Appl. No.: 12/983,596

(22) Filed: Jan. 3, 2011

(51) Int. Cl. E05B 1/00

(52) U.S. Cl. 16/412

(57) ABSTRACT

A handle assembly or moulded to open every enclosed door with horizontal oriented axis of rotation. The handle's arm is curved as an arc of circle whose radius is the shortest distance from handle's position on enclosed door to axis of rotation of said door. The length of said arc of circle is the length of related 45 degrees to 90 degrees' arc of circle depending on handle's position: closer to axis of rotation, handle's arm length will be closer to related 90 degrees' arc of circle. These specifications will provide easier and safe opening without twisting customer effort when pushing handle to open enclosed door and space enough to throw any waste or to pick up any goods or any objects.

### FIELD

Invention relates to handles mounted on enclosed doors to trash bins, to trash receptacles as found in fast food restaurants and delivery access enclosed doors to food or drinks automatic delivery machines or others automates.

### BACKGROUND

At the moment, to operate above mentioned doors you must push the door with your hand as well to pick up goods as to throw away any trash into bin or receptacle.

This operation is very unsatisfactory obviously when you hold a tray as in fast food restaurants. Most of the time, the space you get as pushing the door is not enough, debris soil you, tray may be trapped between enclosed door and receptacle. The same happens with your hand when picking up some goods from automatic delivery machine due to weight or small dimensions of enclosed doors.

Unfortunately, U.S. Pat. No. 6,267,260 B1 by Lyons, U.S. Pat. No. 5,398,374 by Betancourt and U.S. patent application Ser. No. 11/654,070 by Mc Donald, all of them related to trash collectors, do not offer a safe and correct solution as disclosed to follow.

### SUMMARY

When pushing, to run correctly around axis of rotation, the said door's handle must be as an arc of circle whose radius' long is the shortest distance between handle's position on enclosed door and the horizontal oriented axis of rotation of said door. So when running, the mounted handle fit with a perfect circle around axis of rotation and drives safely and correctly pushing force of customers. Any others shapes as described in above mentioned US Patents will twist pushing force and may induce severe muscles injury obviously with heavy enclosed doors to trash collectors in fast food restaurants.

According to arc of circle's handle shape as disclosed above, handle's length has to be neither too long, nor too short. This length match with an arc of circle's length of 45 to 90 degrees' angle, depending on how far handle's position is from axis of rotation: close position will be satisfied with 90 degrees' angle and far position will fit with a 45 degrees' angle.

In brief, there is no universal handle but handle made for each enclosed door's model. The handle's position on the enclosed door is a synthesis with three requirements: the handle's position has to be on the place which provide easiest pushing, so far enough from axis of rotation, the handle's position must provide as much space as possible when operating and finally, the handle's position cannot be too close of door's borders to not hit with enclosing parts when operating.

The handle is made up with a sheet of metal with holes to be attached on the enclosed door with screws or rivets, a tube curved as the related arc of circle and a contact member as a sphere for easy holding by customer. These three parts are welded together or could be design to be produced with plastic injection all together.

### BRIEF DESCRIPTION OF DRAWINGS

FIG. 1 shows an enclosed door 3 mounted with related handle 6 and a drawing part 7 to set the relations between mounted handle's position and door's axis of rotation 1 and make better understanding of the invention.

FIG. 2 shows an opened enclosed door 30 mounted with related handle 50 to disclose space benefit 40.

FIG. 3 shows a handle's model curved as 20 centimetres radius' arc of circle.

### DETAILED DESCRIPTION

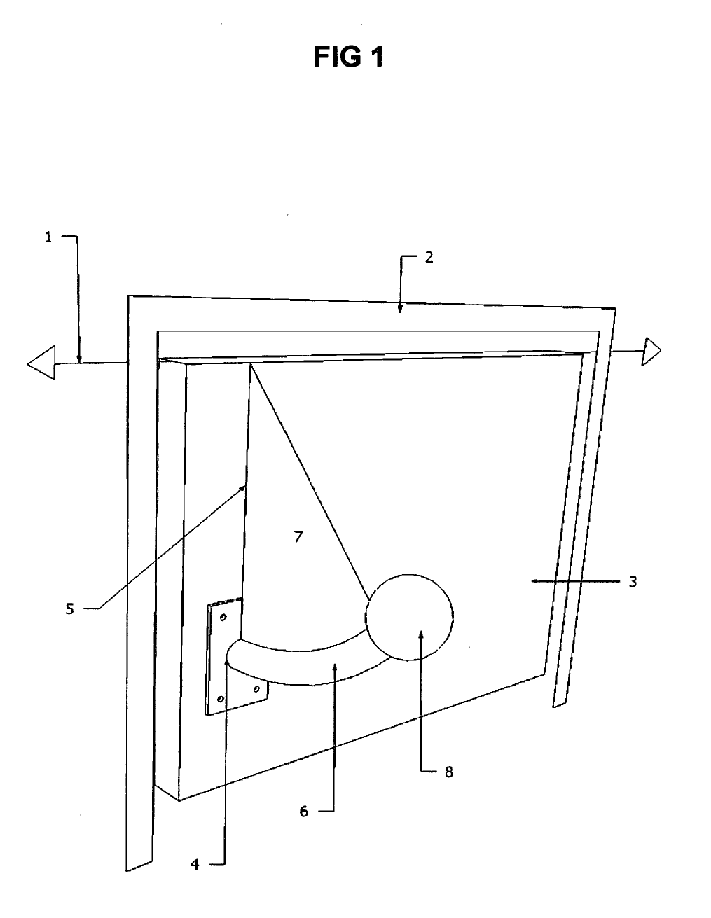

With reference to FIG. 1, the drawn part 7 of the figure is a piece of a circle whose radius 5 is the shortest distance from handle's position 4 on the enclosed door 2 and 3 to the horizontal oriented axis of rotation 1 of said door. Handle's arm 6 is curved as an arc of circle 6 whose radius is 5 and whose length 6 fit with the arc of circle 6 from an angle of 45 degrees of said circle: upper part of 7 is the 45 degrees angle. So handle's length will be correct to provide space enough when pushing on handle's part contact 8 to open enclosed door 3.

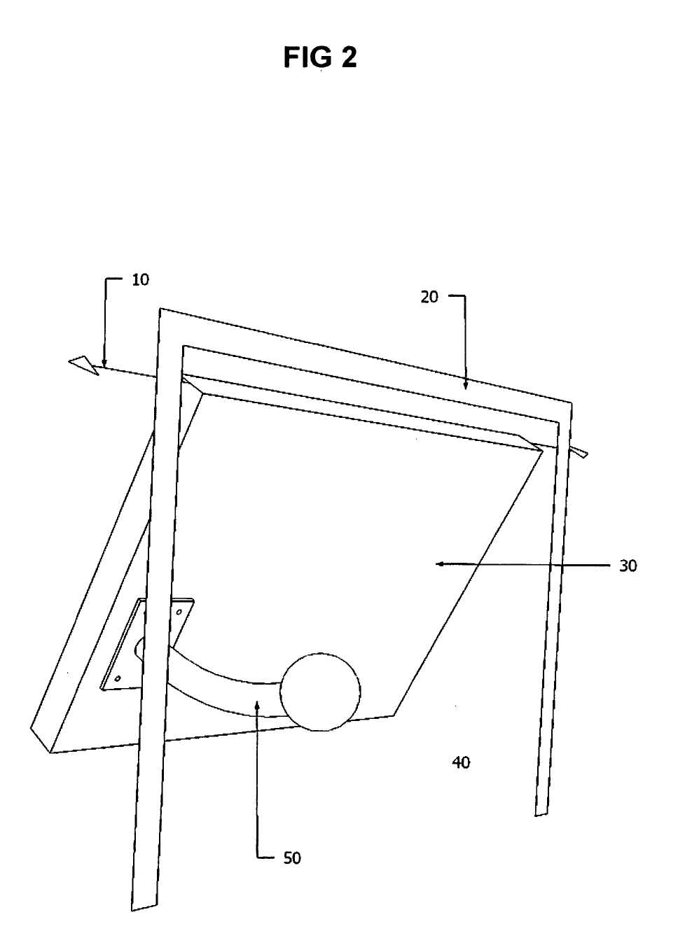

With reference to FIG. 2, the enclosed door 30 is open as long as handle's length 50 to show additional space 40 provided when pushing and rotating around the horizontal oriented axis of rotation 10.

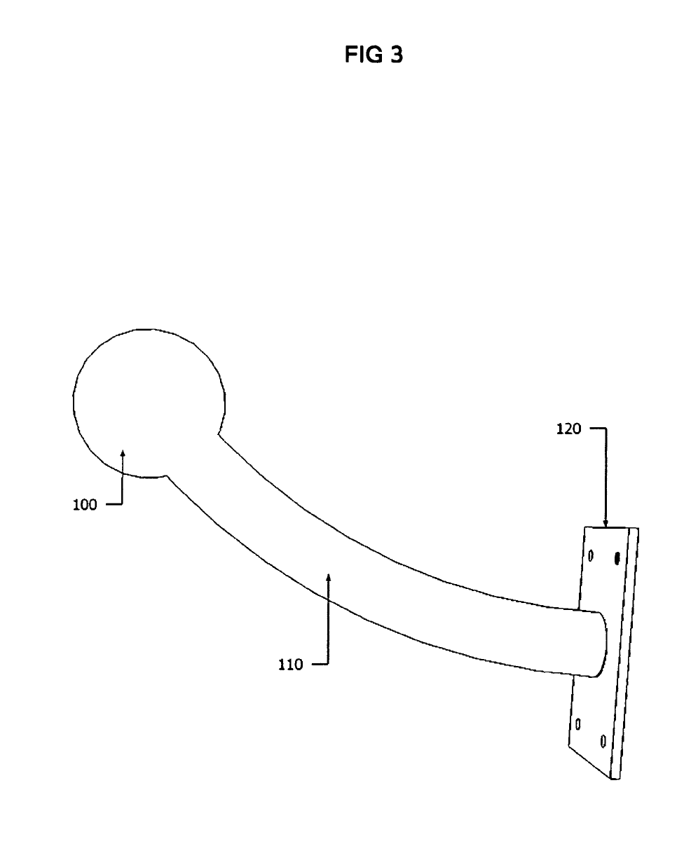

With reference to FIG. 3, a model of handle is drawn; it is composed with a contact member 100 as a sphere which makes easy holding by customers, a second member as a tube or an arm 110 curved as an arc of circle with 20 centimetres radius long and whose length is the related arc of circle of 45 degrees' angle. Finally it is composed with a third member 120 as a sheet of metal with holes to attach handle on the enclosed door with screws or rivets. This third member is sufficiently large to not damage the enclosed door's surface by repeated pressures when using the handle on said door. These three handle's parts are welded together.

### DISCLOSURE SUMMARY

Aspects of the invention have been disclosed on above various paragraphs. Abstracts of disclosure that follow will be also my claims:

I claim:

1. A handle to be mounted on enclosed doors with horizontal oriented axis of rotation and whose handle's arm shape is curved as an arc of circle whose radius' long is the shortest distance from handle's mounted position on the enclosed door to the horizontal oriented axis of rotation of said enclosed door.

2. A handle as previously described whose arm's length is as long as the arc of circle of a 45 degrees' angle to 90 degrees' angle of related circle depending of handle's position mounted on enclosed door.
